(19) United States
(12) Patent Application Publication
(10) Pub. No.: US 2020/0284912 A1
(43) Pub. Date: Sep. 10, 2020

(54) ADAPTIVE SENSOR SYTEM FOR VEHICLE AND METHOD OF OPERATING THE SAME

(71) Applicant: GM GLOBAL TECHNOLOGY OPERATIONS LLC, Detroit, MI (US)

(72) Inventors: Lawrence A. Bush, Shelby Township, MI (US); Zachariah E. Tyree, Shelby Township, MI (US); Shuqing Zeng, Sterling Heights, MI (US); Upali P Mudalige, Oakland Township, MI (US)

(73) Assignee: GM GLOBAL TECHNOLOGY OPERATIONS LLC, Detroit, MI (US)

(21) Appl. No.: 16/296,290

(22) Filed: Mar. 8, 2019

(51) Int. Cl. G01S 17/89; G06N 3/04; G06F 3/01; G06K 9/00; G05D 1/00

(52) U.S. Cl. CPC G01S 17/89; G06N 3/0454; G05D 1/0088; G06K 9/00791; G06F 3/013

(57) ABSTRACT

An adaptive sensor control system for a vehicle includes a controller and a steerable sensor system. The controller generates a perception of the vehicle's environment, including providing at least one perception datum and an associated uncertainty factor for different areas within the perception of the environment of the vehicle. The controller also determines one or more relevance factor for the different areas within the perception of the environment. Furthermore, the controller generates control commands for steering the sensor system toward a physical space in the environment as a function of the uncertainty factor and one or more relevance factors. Accordingly, the sensor system obtains updated sensor input for the physical space to update the perception datum and the associated uncertainty factor for the physical space.

### INTRODUCTION

The technical field generally relates to a sensor system for a vehicle and, more particularly, relates to an adaptive sensor system for a vehicle and a method of operating the same.

Some vehicles include sensors, computer-based control systems, and associated components for sensing the environment of the vehicle, for detecting its location, for detecting objects in the vehicle's path, and/or for other purposes. These systems can provide convenience for human users, increase vehicle safety, etc.

However, these systems often require a large amount of computing power, memory, and/or other limited computer resources. Accordingly, it is desirable to provide a system and methodology for reducing the computing resource/power requirements of a vehicle sensor system. Also, it is desirable to provide a system and methodology for using these limited resources more efficiently. Furthermore, other desirable features and characteristics of the present disclosure will become apparent from the subsequent detailed description and the appended claims, taken in conjunction with the accompanying drawings and this background discussion.

### SUMMARY

An adaptive sensor control system is provided for a vehicle. The adaptive sensor control system includes a controller with a processor programmed to generate a perception of an environment of the vehicle. This includes performing a calculation upon a sensor input to provide, as an output, at least one perception datum and an associated uncertainty factor for different areas within the perception of the environment of the vehicle. Furthermore, the adaptive sensor control system includes a sensor system configured to provide the sensor input to the processor. The sensor system is selectively steerable with respect to a physical space in the environment according to a control signal. The processor is programmed to determine a relevance factor for the different areas within the perception of the environment. Furthermore, the processor is configured to generate the control command for steering the sensor system toward a physical space in the environment as a function of the uncertainty factor and the relevance factor determined for the different areas of the perception. Additionally, the sensor system is configured to steer toward the physical space in the environment according to the control command to obtain updated sensor input for the processor to update the at least one perception datum and the associated uncertainty factor for the physical space.

In some embodiments, the processor is programmed to perform a Bayesian calculation upon the sensor input to provide, as the output, the at least one perception datum and the associated uncertainty factor for the different areas within the perception.

Furthermore, in some embodiments, the processor is programmed to generate and populate a cell of an occupancy grid with the at least one perception datum and the associated uncertainty factor according to the Bayesian calculation.

In some embodiments, the controller includes a saliency module programmed to determine a saliency relevance factor for the different areas by accessing a preprogrammed human gaze model. The saliency module is programmed to process the sensor input to recognize, according to the human gaze model, conditions in areas of the perception that correspond to a driving scenario stored in the human gaze model; indicate, according to the human gaze model, which of the areas a human driver visually attends for the recognized conditions; and calculate the saliency relevance factor, including calculating higher saliency relevance factors for those areas a human driver visually attends. Also, the processor is configured to generate the control command for steering the sensor system as a function of the uncertainty factor and the saliency relevance factor.

Moreover, in some embodiments, the saliency module processes the sensor input through a deep convolutional neural network having a multi-branch architecture including a segmentation component and an optical flow that encodes information about relative movement within an image represented in the sensor input.

In some embodiments, the controller includes a maneuver risk module programmed to determine a maneuver risk relevance factor for the different areas, including processing the sensor input to: recognize a current situation of the vehicle and accordingly predict the risk of executing a particular vehicle maneuver; determine the degree of influence that the different areas on the prediction; and calculate the maneuver risk relevance factor for the different areas according to the determined degree of influence, including calculating higher maneuver risk relevance factors for areas having higher degrees of influence. The processor is configured to generate the control command for steering the sensor system as a function of the uncertainty factor and the maneuver risk relevance factor.

In some embodiments, the maneuver risk module is programmed to generate a Markov random field (MRF) to recognize the current situation.

Furthermore, in some embodiments, the sensor system includes a first sensing device and a second sensing device. The first and second sensing devices have different modalities, and the first and second sensing devices are configured for providing sensor input for a common area of the perception as the sensor input.

The first sensing device includes a camera system and the second sensing device includes a lidar system in some embodiments.

In some embodiments, the processor includes a salience module and a maneuver risk module. The salience module is configured to process the sensor input from the camera system and provide salience data corresponding to the relevance factor for the different areas within the perception. The maneuver risk module is configured to process the sensor input from the lidar system and provide maneuver risk data corresponding to the relevance factor for the different areas within the perception.

In example embodiments of the present disclosure, the sensor system is configured to steer toward the selected physical space area according to the control command by at least one of: turning ON a sensing device of the sensor system between an OFF mode and an ON mode; directing a signal from the sensing device toward the selected physical space; actuating the sensing device toward the selected physical space; focusing the sensing device on the selected physical space; and changing sensor resolution of the sensing device with respect to the selected physical space.

Moreover, a method of operating an adaptive sensor control system of a vehicle is provided. The method includes providing sensor input from a sensor system to an on-board controller having a processor. The method also includes generating, by the processor, a perception of an environment of the vehicle, including performing a calculation upon the sensor input to provide, as an output, at least one perception datum and an associated uncertainty factor for different areas within the perception of the environment of the vehicle. Additionally, the method includes determining, by the processor, a relevance factor for the different areas within the perception of the environment. Also, the method includes generating, by the processor, a control command for steering the sensor system toward a physical space in the environment as a function of the uncertainty factor and the relevance factor determined for the different areas of the perception. Furthermore, the method includes steering the sensor system toward the physical space in the environment according to the control command to obtain updated sensor input for the processor to update the at least one perception datum and the associated uncertainty factor for the physical space.

In some embodiments, generating the perception includes: performing, by the processor, a Bayesian calculation upon the sensor input to provide, as the output, the at least one perception datum and the associated uncertainty factor for the different areas within the perception; and populating a cell of an occupancy grid with the at least one perception datum and the associated uncertainty factor according to the Bayesian calculation.

Furthermore, in some embodiments, determining the relevance factor includes: determining a saliency relevance factor for the different areas by accessing a preprogrammed human gaze model; recognizing, according to the human gaze model, conditions in areas of the perception that correspond to a driving scenario stored in the human gaze model; indicating, according to the human gaze model, which of the areas a human driver visually attends for the recognized conditions; and calculating the saliency relevance factor, including calculating higher saliency relevance factors for those areas a human driver visually attends. Also, generating the control command includes generating the control command for steering the sensor system as a function of the uncertainty factor and the saliency relevance factor.

Determining the relevance factor, in some embodiments, includes determining a maneuver risk relevance factor for the different areas. This includes processing the sensor input to: recognize a current situation of the vehicle and accordingly predict the risk of executing a particular vehicle maneuver; determine the degree of influence that the different areas on the prediction; and calculate the maneuver risk relevance factor for the different areas according to the determined degree of influence, including calculating higher maneuver risk relevance factors for areas having higher degrees of influence. Also, generating the control command includes generating the control command for steering the sensor system as a function of the uncertainty factor and the maneuver risk relevance factor.

Moreover, the method includes generating a Markov random field (MRF) to recognize the current situation in some embodiments.

The method, in some embodiments, includes providing the sensor input from a first sensing device and a second sensing device of the sensor system. The first and second sensing devices have different modalities. The first and second sensing devices provide sensor input for a common area of the perception.

Furthermore, in some embodiments of the method, steering the sensor system includes at least one of: turning ON a sensing device of the sensor system between an OFF mode and an ON mode; directing a signal from the sensing device toward the selected physical space; actuating the sensing device toward the selected physical space; focusing the sensing device on the selected physical space; and changing sensor resolution of the sensing device with respect to the selected physical space.

Additionally, a vehicle is provided that includes a controller with a processor programmed to generate a perception of an environment of the vehicle. This includes performing a Bayesian calculation upon a sensor input to provide an occupancy grid representing the perception. The occupancy grid is populated with at least one perception datum and an associated uncertainty factor for different cells within the occupancy grid. The vehicle also includes a sensor system configured to provide the sensor input to the processor, wherein the sensor system is selectively steerable with respect to a physical space in the environment according to a control signal. The physical space corresponds to at least one of the cells of the occupancy grid. The processor is programmed to determine a saliency relevance factor for the different cells within the occupancy grid. The processor is also programmed to determine a maneuver risk relevance factor for the different cells within the occupancy grid. Moreover, the processor is configured to generate the control command for steering the sensor system toward the physical space in the environment as a function of the uncertainty factor, the saliency relevance factor, and the maneuver risk relevance factor. The sensor system is configured to steer toward the physical space according to the control command to obtain updated sensor input for the processor to update the at least one perception datum and the associated uncertainty factor for the physical space.

In some embodiments of the vehicle, the sensor system is configured to steer toward the selected physical space area according to the control command by at least one of: turning ON a sensing device of the sensor system between an OFF mode and an ON mode; directing a signal from the sensing device toward the selected physical space; actuating the sensing device toward the selected physical space; focusing the sensing device on the selected physical space; and changing sensor resolution of the sensing device with respect to the selected physical space.

### BRIEF DESCRIPTION OF THE DRAWINGS

The exemplary embodiments will hereinafter be described in conjunction with the following drawing figures, wherein like numerals denote like elements, and wherein:

FIG. 1 is a schematic illustration of a vehicle with an adaptive sensor system according to example embodiments of the present disclosure;

FIG. 2 is a schematic illustration of an adaptive sensor control system of the vehicle of FIG. 1 according to example embodiments;

FIG. 3 is an illustration of a grid with a plurality of cells that collectively represent a perceived environment of the vehicle as generated by the adaptive sensor system of the present disclosure;

FIG. 4 is a schematic illustration of a salience module of the adaptive sensor control system of the present disclosure;

FIG. 5 is a schematic illustration of a maneuver risk module of the adaptive sensor control system of the present disclosure; and

FIG. 6 is a circular flow diagram illustrating a method of operating the adaptive sensor system of the present disclosure according to example embodiments of the present disclosure.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

The subject matter described herein discloses apparatus, systems, techniques and articles for operating an adaptive sensor system of a vehicle. The described apparatus, systems, techniques and articles are associated with a sensor system of a vehicle as well as a controller for controlling one or more sensing devices of the sensor system. To this end, the controller may employ at least one adaptive algorithm, which changes based on the information available and on a priori information.

The sensing devices may include a combination of sensors of different operational modalities for gathering a variety of sensor data. For example, the sensing devices may include one or more cameras as well as radar-based or laser-based sensing devices (e.g., lidar sensing devices).

At least one sensing device is steerable toward a selected physical space within the environment of the vehicle to change how the sensor system collects data. In this context, the term “steerable sensing device” is to be interpreted broadly to encompass a sensing device, regardless of type, that is configured to: a) actuate toward and/or focus on a selected area within the vehicle environment; b) turn ON from an OFF mode to begin gathering sensor data from the respective area of the environment; c) change resolution in a selected area within the sensing device's field of view; or d) otherwise direct a sensor signal toward a selected space within the vehicle environment.

During operation, the sensor system gathers sensor data, which is received by a processor of the controller. The processor may be programmed to convert the sensor data into a perception (i.e., belief) about the vehicle and/or its environment. For example, the processor may determine where surrounding vehicles are located in relation to the subject vehicle, predict the path of surrounding vehicles, determine and recognize pavement markings, locate pedestrians and cyclists and predict their movements, and more.

In some embodiments, the processor generates an occupancy grid with a plurality of cells that collectively represent the perceived environment of the vehicle. The processor calculates at least one perception datum for the different cells within the grid. The perception datum represents a perceived element of the vehicle's environment. The processor also calculates an uncertainty factor for the different cells, wherein the uncertainty factor indicates the processor's uncertainty about the perception within that cell. The perception data and uncertainty factors may be calculated from the sensor input using one or more Bayesian algorithms.

The perception as well as the uncertainty factors included in the cells of the grid may be updated continuously as the vehicle operates. Additionally, the processor determines situational relevance of the different cells within the grid. Relevance may be determined in various ways.

In some embodiments, the processor may receive and process the sensor input, recognize the vehicle's current situation, and accordingly determine/predict where a human's gaze would be directed therein. Those areas can be merged with corresponding grid cells and the processor identifies those cells as having higher relevance than other cells of the grid. In some embodiments, the processor may calculate a salience relevance factor for the different cells.

In addition, or in the alternative, the processor may receive and process the sensor input, recognize the vehicle's current situation, and accordingly determine/predict the risk of executing a particular vehicle maneuver. Furthermore, the processor may determine the degree of influence that different areas in the vehicle's environment have on this maneuver risk prediction process. The areas that more heavily influence the maneuver risk prediction can be merged with corresponding grid cells and the processor identifies those cells as having higher relevance than other cells of the grid. Accordingly, the processor calculates a maneuver risk relevance factor for the different cells.

Accordingly, the processor may perform certain operations that are dependent on the distribution of uncertainty factors, the salience relevance factors, and/or the maneuver risk relevance factor cells across the grid. In some embodiments, for example, the processor may generate sensor control commands according to these factors. More specifically, the processor may generate the distribution of uncertainty and relevance factors for the grid and identify those grid cells having relatively high uncertainty factors in combination with relatively high relevance factors. The processor may generate control commands for the sensor system such that at least one sensing device is steered toward the corresponding area in the vehicle's environment.

Next, the sensor system provides the processor with updated sensor input, including sensor input for the areas determined to be of higher uncertainty and relevance. The processor processes the updated sensor input and updates the perception, for example, by re-calculating the perception datum and uncertainty factors for at least some of the grid cells. In some embodiments, the processor updates these factors for the areas identified as being high uncertainty and high relevance. From these updates, the processor generates additional sensor control commands for steering the sensing devices towards areas of higher uncertainty/relevance. The sensor system provides more sensor input, the control system updates the perception and generates sensor control commands based on the updated uncertainty and/or relevance factors, and so on.

These processes may cyclically repeat as the vehicle moves through the environment. As such, the system automatically adapts the sensor operations substantially in real time to the vehicle's current environment so that the sensor system tends to monitor physical spaces outside the vehicle where perception uncertainty is higher and/or where there is relatively high relevance for the current driving conditions.

The system may operate with reduced computing resources and/or reduced power requirements compared to existing systems as will be discussed. For example, the sensor systems may include various visual sensing devices which are limited by certain pixel budgets. The systems and methods of the present disclosure allows efficient use of these pixel budgets. Other benefits are discussed below.

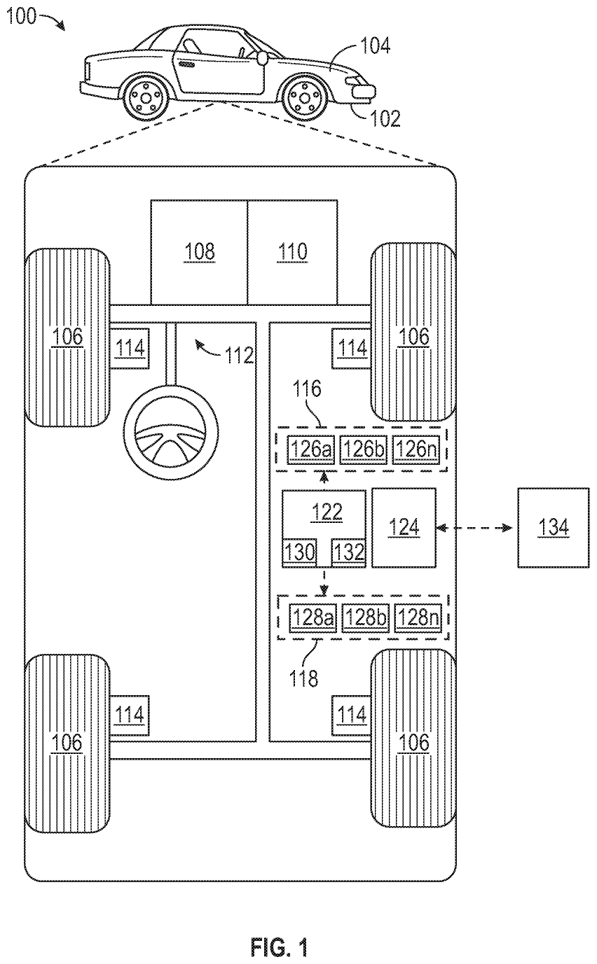

FIG. 1 is a block diagram of an example vehicle 100 that employs one or more embodiments of the present disclosure. The vehicle 100 generally includes a chassis 102 (i.e., a frame), a body 104 and a plurality of wheels 106 (e.g., four wheels). The wheels 106 are rotationally coupled to the chassis 102. The body 104 is supported by the chassis 102 and defines a passenger compartment, a storage area, and/or other areas of the vehicle 100.

It will be appreciated that the vehicle 100 may be one of a variety of types without departing from the scope of the present disclosure. For example, the vehicle 100 may be a passenger car, a truck, a van, a sports utility vehicle (SUV), a recreational vehicle (RV), a motorcycle, a marine vessel, an aircraft, etc. Also, the vehicle 100 may be configured as a passenger-driven vehicle such that a human user ultimately controls the vehicle 100. In additional embodiments, the vehicle 100 may be configured as an autonomous vehicle that is automatically controlled to carry passengers or other cargo from one location to another. In further embodiments, the vehicle 100 may be configured as a semi-autonomous vehicle wherein some operations are automatically controlled, and wherein other operations are manually controlled. In the case of a semi-autonomous vehicle, the teachings of the present disclosure may apply to a cruise control system, an adaptive cruise control system, a parking assistance system, and the like.

The vehicle 100 may include a propulsion system 108, a transmission system 110, a steering system 112, a brake system 114, a sensor system 116, an actuator system 118, a communication system 124, and at least one controller 122. In various embodiments, the vehicle 100 may also include interior and/or exterior vehicle features not illustrated in FIG. 1, such as various doors, a trunk, an air conditioner, an entertainment system, a lighting system, touch-screen display components (such as those used in connection with navigation systems), and the like.

The propulsion system 108 may, in various embodiments, include an internal combustion engine, an electric machine such as a traction motor, and/or a fuel cell propulsion system. The transmission system 110 may be configured to transmit power from the propulsion system 108 to the vehicle wheels 106 according to a plurality of selectable speed ratios for propelling the vehicle 100. The brake system 114 may include one or more brakes configured to selectively decelerate the respective wheel 106 to, thereby, decelerate the vehicle 100.

The vehicle actuator system 118 may include one or more actuator devices 128a-128n that control one or more vehicle features such as, but not limited to, the propulsion system 108, the transmission system 110, the steering system 112, the brake system 114 and/or the sensor system 116. The actuator devices 128a-128n may comprise electric motors, linear actuators, hydraulic actuators, pneumatic actuators, or other types.

The communication system 124 may be configured to wirelessly communicate information to and from other entities 134, such as but not limited to, other vehicles (“V2V” communication), infrastructure (“V2I” communication), networks (“V2N” communication), pedestrian (“V2P” communication), remote transportation systems, and/or user devices. In an exemplary embodiment, the communication system 124 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The sensor system 116 may include one or more sensing devices 126a-126n that sense observable conditions of the environment of the vehicle 100 and that generate sensor data relating thereto as will be discussed in detail below. Sensing devices 126a-126n might include, but are not limited to, radar devices, lidar devices, global positioning systems (GPS), optical cameras (e.g., forward facing, 360-degree, rear-facing, side-facing, stereo, etc.), image sensors, thermal (e.g., infrared) cameras, ultrasonic sensors, odometry sensors (e.g., encoders) and/or other sensors.

The vehicle 100 may include at least two sensing devices 126a-126n having different modalities and that provide corresponding data for a common area in the environment of the vehicle 100. For example, one sensing device 126a may comprise a camera while another sensing device 126b may comprise lidar, which are both able to detect conditions generally within the same physical space within the vehicle's environment. The first sensing device 126a (the camera in this example) may capture an image or a series of frames of a space in front of the vehicle 100, and the second sensing device 126b (the lidar) may simultaneously direct sensor signals (laser beams) toward the same space in front of the vehicle 100 and receive return signals for detecting characteristics of this space.

Furthermore, in some embodiments, one or more of the sensing devices 126a-126n may be selectively steered (i.e., adjusted, directed, focused, etc.) to change how the sensor system 116 collects data. For example, one or more of the sensing devices 126a-126n may be steered or directed to focus on a particular space within the environment of the vehicle 100 to thereby gather information about that particular space of the environment. For example, at least one sensing device 126a-126n may be selectively turned between ON and OFF modes such that different numbers of the sensing device 126a-126n may be utilized at different times for gathering sensor data from a selectively variable field of the environment. Also, in some embodiments, the focus of at least one sensing device 126a-126n may be selectively adjusted. For example, in the case of a camera system, at least one camera lens may be selectively actuated to change its focus. Also, in some embodiments, the gain of at least one camera may be selectively adjusted to vary the visual sensor data that is gathered thereby. Additionally, in the case of a lidar or other comparable system, the number of beams directed toward a particular space outside the vehicle 100 may be selectively varied such that the sensor system 116 gathers more information about that particular space. Furthermore, one or more sensing devices 126a-126n may selectively change resolution for a particular area in the environment. Moreover, at least one sensing device 126a-126n may have one or more of the actuator devices 128a-128n associated therewith that may be selectively actuated for steering the sensing device 126a-126n.

The controller 122 includes at least one on-board processor 130. The processor 130 may be any custom-made or commercially available processor, a central processing unit (CPU), a graphics processing unit (GPU), an application specific integrated circuit (ASIC) (e.g., a custom ASIC implementing a neural network), a field programmable gate array (FPGA), an auxiliary processor among several processors associated with the controller 122, a semiconductor-based microprocessor (in the form of a microchip or chip set), any combination thereof, or generally any device for executing instructions.

The controller 122 further includes at least one on-board computer-readable storage device or media 132. The computer readable storage device or media 132 may include volatile and nonvolatile storage in read-only memory (ROM), random-access memory (RAM), and keep-alive memory (KAM), for example. KAM is a persistent or non-volatile memory that may be used to store various operating variables while the processor 130 is powered down. The computer-readable storage device or media 132 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 122 in controlling the vehicle 100.

The instructions may include one or more separate programs, each of which comprises an ordered listing of executable instructions for implementing logical functions. The instructions, when executed by the processor 130, receive and process signals (e.g., sensor data) from the sensor system 116, perform logic, calculations, methods and/or algorithms for controlling the various components of the vehicle 100, and to generate control signals that are transmitted to those components. More specifically, the processor 130 may generate control signals that are transmitted to the actuator system 118 to automatically control the components of the vehicle 100 based on the logic, calculations, methods, and/or algorithms. Furthermore, the processor 130 may generate control commands that are transmitted to one or more of the sensing devices 126a-126n of the sensor system 116.

Although only one controller 122 is shown in FIG. 1, embodiments of the vehicle 100 may include any number of controllers 122 that communicate over a suitable communication medium or a combination of communication mediums and that cooperate to process the sensor signals, perform logic, calculations, methods, and/or algorithms, and generate control signals to automatically control features of the vehicle 100.

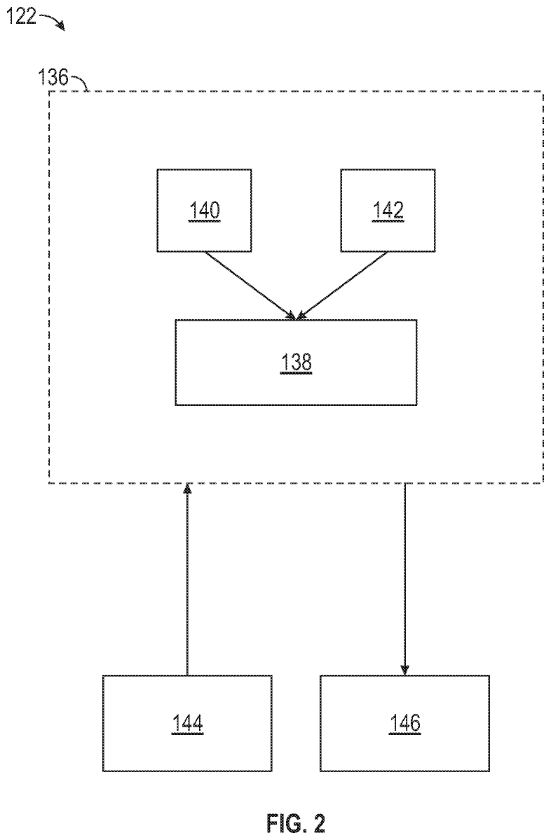

In accordance with various embodiments, the controller 122 may implement an adaptive sensor control system 136 as shown in FIG. 2. That is, suitable software and/or hardware components of the controller 122 (e.g., the processor 130 and the computer-readable storage media 132) may be utilized to provide the adaptive sensor control system 136, which is used to control one or more of the sensing devices 126a-126n of the sensor system 116. As shown, sensor input 144 from one or more of the sensing devices 126a-126n may be received by the sensor control system 136, which, in turn, processes the sensor input 144 and generates and provides one or more control commands as command output 146 for ultimately controlling the sensing devices 126a-126n. In some embodiments, the output 146 may cause one or more sensing devices 126a-126n to steer (i.e., be directed or focused) toward a particular space within the environment of the vehicle 100. Accordingly, additional sensor input may be gathered from the designated space to thereby update the perception of that space. Thus, additional sensor input 144 may be provided, the processor 122 may the sensor input 144, provide additional command output 146 for gathering more sensor input 144, and so on continuously during operations.

In various embodiments, the instructions of the sensor control system 136 may be organized by function or system. For example, as shown in FIG. 2, the sensor control system 136 may include a perception module 138, a salience module 140, and a maneuver risk module 142. As can be appreciated, in various embodiments, the instructions may be organized into any number of systems (e.g., combined, further partitioned, etc.) as the disclosure is not limited to the present examples.

Generally, from the sensor input 144, the perception module 138 generates a perception of the vehicle's environment, including determining perception data for different areas within the perception and including determining an associated uncertainty factor for the different areas. The different areas of the perception correspond to different physical spaces in the vehicle's environment. The salience module 140 and the maneuver risk module 142 recognize one or more aspects of the vehicle's current environment from the sensor input 144. The salience module 140 determines where a human driver would look in a comparable environment and, thus, identifies those areas as having higher relevance than others. Likewise, the maneuver risk module 142 determines which areas are more relevant for determining the risk of performing certain maneuvers and, thus, identifies those areas as having higher relevance than others. Ultimately, the sensor control system 136 generates the command output 146 based on the uncertainty and relevance determinations. Accordingly, the sensing devices 126a-126n may be steered toward areas of higher perception uncertainty and toward areas that are more relevant. Then, additional, updated sensor input 144 may be gathered and the cycle can continue.

The perception module 138 synthesizes and processes the sensor input 144 acquired from the sensing devices 126a-126n and generates a perception of the environment of the vehicle 100. In some embodiments, the perception module 138 interprets, predicts the presence, location, classification, and/or path of objects and features of the environment of the vehicle 100. The perception module 138 can incorporate information from two or more of the sensing devices 126a-126n in generating the perception. In some embodiments, the perception module 138 can perform multiple on-board sensing tasks concurrently in a neural network using deep learning algorithms that are encoded in the computer readable media and executed by the one or more processors. Example on-board sensing tasks performed by the example perception module 138 may include object detection, free-space detection, and object pose detection. Other modules in the vehicle 100 may use outputs from the on-board sensing tasks performed by the example perception module 138 to estimate current and future world states to assist with operation of the vehicle 100, for example, in an autonomous driving mode or semi-autonomous driving mode. The perception module 138 may additionally incorporate features of a positioning module to determine a position (e.g., a local position relative to a map, an exact position relative to a lane of a road, a vehicle heading, etc.) of the vehicle 100 relative to the environment. As can be appreciated, a variety of techniques may be employed to accomplish this localization, including, for example, simultaneous localization and mapping (SLAM), particle filters, Kalman filters, Bayesian filters, Markov Random Field generators, and the like. In various embodiments, the perception module 138 implements machine learning techniques to assist the functionality of the perception module 138, such as feature detection/classification, mapping, sensor integration, ground-truth determination, and the like.

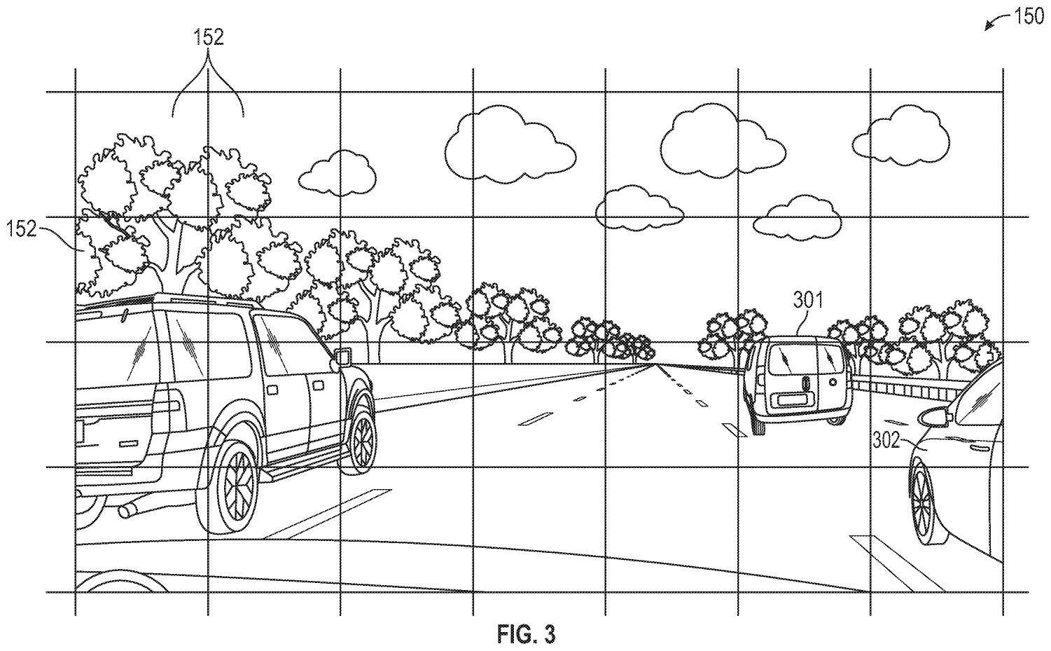

Specifically, in some embodiments, the perception module 138 may receive the sensor input 144 and generate an occupancy grid 150 that is divided into a plurality of cells 152 as represented in FIG. 3. In other words, the perception module 138 may be programmed to process the sensor input 144 and perform occupancy grid mapping operations. The cells 152 may collectively represent the perceived environment of the vehicle. In the illustrated embodiment, this includes areas located ahead of the vehicle 100. The cells 152 represent different physical areas of the vehicle's environment.

As illustrated, the grid 150 may be a two-dimensional matrix with the cells 152 arranged in rows and columns. (Rows are labelled numerically and columns are labelled alphabetically in FIG. 3 for purposes of discussion.) The occupancy grid 150 represents the map of the vehicle's environment as an evenly spaced field of binary random variables, each representing the presence of a vehicle, pedestrian, curb, or other obstacle at respective locations. It will be appreciated, however, that this is merely one example that is simplified to illustrate the principals of the adaptive sensor control system 136. The cells 152 may correspond to any number or group of pixels. Also, in other embodiments, different cells 152 may have different sizes from each other, and the arrangement of the cells 152 may be uneven and irregular. Also, in some embodiments, an object (e.g., a neighboring vehicle) within the grid 150 may define an individual cell 152 with another object (e.g., a pedestrian) within the grid 150 defining another cell 152.

The perception module 138 populates the cells 152 of the grid 150 with various data. Specifically, the perception module 138 determines perception data for the individual cells 152 within the occupancy grid 150. In addition, the perception module 138 may be configured for determining a degree of uncertainty as to the perception data for the different cells. In other words, the perception module 138 may receive the sensor input 144 from the sensing devices 126a-126n, generate the perception, and the perception module 138 may evaluate uncertainty with respect the to the perception generated. In some embodiments, the perception module 138 calculates an uncertainty factor for the plurality of cells 152.

The uncertainty factor may depend on certain causes. For example, if two different sensing devices 126a-126n provide conflicting sensor input 144 about a certain area of the environment, then the perception module 138 may evaluate the perception as having relatively high uncertainty in the corresponding cell 152. The calculated uncertainty factor may reflect this high uncertainty. In contrast, if the different sensing devices 126a-126n provide consistent sensor input 144, then the perception module 138 may evaluate the perception as having relatively low uncertainty, and the uncertainty factor for the respective cell 152 can reflect this low uncertainty.

In some embodiments, the perception module 138 may generate the perception (i.e., calculate the perception and uncertainty data for the cells 152) using one or more Bayesian algorithms. The calculations are used to quantify, for different cells 152, expected error (i.e., information gain) computed as true occupancy (Ø∈{0,1}), minus an estimate (p) squared, multiplied by probability with respect to occupancy. In this context, occupancy grid algorithms are used to compute approximate posterior estimates for these random variables. Stated differently, expected prediction error (i.e., the uncertainty factor) may be calculated according to the following equation (1):

$$E [ {( ∅ - p )}^{2} ] = {\sum }_{∅ ∈ \{ 0 , 1 \}} {( ∅ - p )}^{2} P ( ∅ ) = {( 0 - p )}^{2} ( 1 - p ) + {( 1 - p )}^{2} p = p ( 1 - p )$$

wherein ¥ represents true occupancy, p represents the estimate, and P represents probability. Also, a Bayesian update may be performed for a given cell 152 according to the following equation (2):

$${p}_{post} = \frac{{( 1 - a )}^{( n - k )} {a}^{k} p}{{( 1 - a )}^{( n - k )} {a}^{k} p + {( 1 - b )}^{( n - k )} {b}^{k} ( 1 - p )}$$

wherein n represents the number of observations at a given cell, k represents the number of detections, a represents detections (P), b represents false-alarm (P), and p represents occupancy (P). Accordingly, the perception module 138 may calculate posteriors for a given cell 152 according to equation (2). Additionally, the perception module 138 may calculate the expected future uncertainty for the cells 152 according to the following equation (3):

E[RMSE]=\sqrt{p(1−p)}(\sqrt{ab}+\sqrt{(1−a)(1−b)})ⁿ

Thus, the perception module 138 may create a heuristic model which can be used for adaptively controlling the sensing devices 126a-126n. For a given cell 152 within the grid 150, the perception module 138 determines how much uncertainty will be reduced if one or more sensing devices 126a-126n were driven to the corresponding physical space in the environment. In some embodiments, the adaptive sensor control system 136 relies on this information (uncertainty reduction in the cells 152) when generating sensor control commands to the sensing devices 126a-126n.

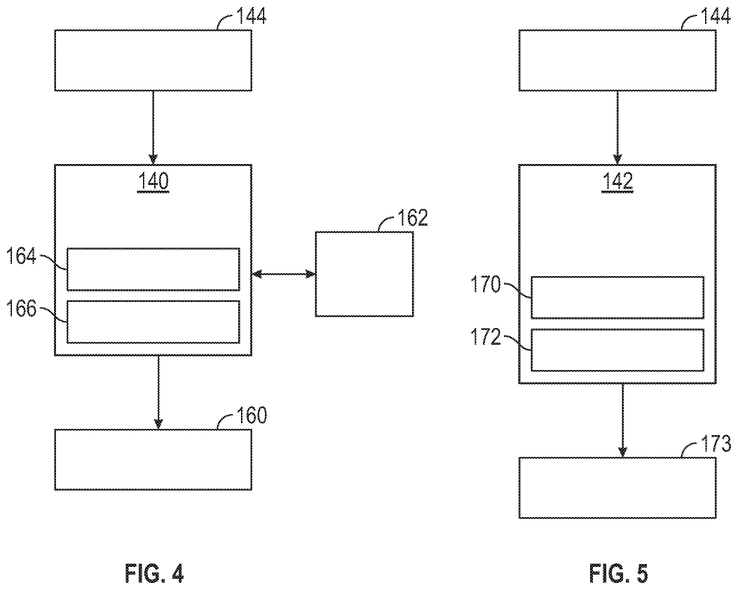

The perception module 138 may receive relevancy data from the salience module 140 in order to identify cells 152 within the grid 150 that are more relevant to the current driving situation. As represented in FIG. 4, the salience module 140 may synthesize and process the sensor input 144 acquired from the sensing devices 126a-126n and provide salience data 160 identifying which cells 152 of the grid 150 have higher relevance to the task of driving under recognized current conditions. The salience module 140 may recognize the grid 150 and predict where a human gaze would be directed within the grid 150. The salience module 140 may access a human gaze model 162 that is stored in the storage media 132 to perform these operations.

The human gaze model 162 may be a preprogrammed model that allows the salience module 164 to recognize patterns and/or other features in the sensor input 144 that correlate to stored driving scenarios. In addition, the human gaze model 162 indicates where a human driver's gaze is directed in the stored driving scenarios. The human gaze model 162 may be trained in various ways. For example, a test vehicle may be driven with a vehicle-mounted camera. This camera may record a test scenario, such as a multi-frame video (e.g., a sixteen-frame video) recording the current test scenario. Also, a human driver may be wearing a gaze-tracking device with an outward facing camera for simultaneously recording the test scenario, and the wearable device may also include an inward facing sensor that tracks the driver's gaze angle during the scenario. The gaze-tracking device may operate at a higher frame rate than the two outward facing cameras; therefore, for a given frame, there may be a high number of points associated with eye movement, and a highly reliable gaze-based data distribution may be obtained. The visual information and gaze-tracking information recorded from the vehicle mounted camera and the wearable gaze-tracking device may be aligned, merged, and associated such that the driver's gaze angle is learned throughout the test scenario. The human gaze model 162 may be trained in this way for a large number of test scenarios, and the data may be stored within the storage media 132 as the human gaze model 162. Accordingly, the human gaze model 162 may reflect that a driver, while driving in the recognized scenario, tends to gaze at certain cells 152 and not others. For example, the model 162 can reflect how a driver's gaze follows curb edges, directs to the wheels of neighboring vehicles, lingers on the head and face area of pedestrians and other drivers, etc. In contrast, the model 162 reflects that the driver's gaze spends less time directed at or toward the sky, billboards, distant areas, and the like.

As shown in FIG. 4, the salience module 140 may include a neural network 166, such as a deep convolutional neural network having a multi-branch architecture including a segmentation component 164 and an optical flow that encodes information about relative movement within an image. During operations of the adaptive sensor control system 136, the salience module 140 may receive at least some of the sensor input 144 from the sensing devices 126a-126n. The salience module 140 may, for example, receive visual data from a camera system. The salience module 140 may segment this sensor input 144 into the different cells 152 of the grid 150, recognize the current driving conditions, and determine which cells 152 a human driver's gaze would be directed under a comparable driving scenario. In other words, the sensor input 144 and gaze information from the human gaze model 162 may be processed through a neural network 166 in order to recognize the current driving conditions and to indicate which cells 152 a human driver gazes for those driving conditions. The neural network 166 may process the sensor input 144 and human gaze input for the different cells 152 and calculate the salience data 160 and assign the cells 152 individual relevance factors (e.g., a pixel-wide score indicating the degree of relevancy). The salience module 140 may output the salience data 160 to the perception module 138 for performing a Bayesian update on the different cells 152 (e.g., using equation (3), above). Thus, the perception module 138 may update the grid 150, and in some situations, the highly relevant cells 152 identified by the salience module 140 may be updated with additional sensor input 144 as will be discussed.

Accordingly, the salience module 140 may provide a predictive saliency distribution for the grid 150. It may comprise a spatio-temporal camera-based predictive distribution (a probability distribution conditioned on the recognized scenario), and the distribution indicates where human drivers would visually attend. In some embodiments, this may be a context-driven estimator over what is important in the scenario. Furthermore, in some embodiments, the sensing devices 126a-126n may be steered based on this relevance data.

Additionally, in various embodiments, the maneuver risk module 142 may synthesize and process the sensor input 144 acquired from at least some of the sensing devices 126a-126n (e.g., from a camera system, a radar system, and/or a lidar system). The maneuver risk module 142 may, as a result, provide data corresponding to cells 152 of the grid 150 that are particularly relevant for the vehicle's environment. In other words, the maneuver risk module 142 may receive the sensor input 144 and output relevance factors for one or more of the cells 152.

As shown in FIG. 5, the maneuver risk module 142 may include a vehicle positioning component 170 and a dynamic object component 172. The vehicle positioning component 170 is configured to determine where the vehicle 100 is located or positioned within the grid 150, and the dynamic object component 172 is configured to determine where moving objects are located relative to the vehicle 100 within the grid 150. Sensor input 144 from the sensing devices 126a-126n may be processed by the maneuver risk module 142 for making these determinations. Also, in some embodiments, the vehicle positioning component 170 and/or the dynamic object component 172 communicate (via the communication system 124) with the other entities 134 to determine the relative positions of the vehicle 100 and the surrounding vehicles, pedestrians, cyclists, and other dynamic objects.

More specifically, the sensor input 144 to the maneuver risk module 142 may be radar-based and/or laser-based (lidar) detections from one or more of the sensing devices 126a-126n. The maneuver risk module 142 may filter and determine which of the detections are dynamic objects (moving objects that are actually on the road).

The maneuver risk module 142 may process this information and generate a Markov random field (MRF) (i.e., Markov network, undirected graphical model, etc.) to represent the dependencies therein. Using this information, and using a reinforcement training process, the maneuver risk module 142 may determine (i.e., predict) the risk associated with initiating (i.e., executing) a particular maneuver (e.g., a right turn into cross traffic). From that prediction function, the maneuver risk module 142 may determine the degree to which individual cells 152 influence the risk prediction output. In some embodiments, the maneuver risk module 142 may identify which of the sensing devices 126a-126n have the most influence on the maneuver risk prediction, and those sensing devices 126a-126n may correlate to certain ones of the cells 152. The cells 152 that are identified as having higher influence on risk prediction are identified by the maneuver risk module 142 as being more relevant than the others.

Accordingly, the maneuver risk module 142 may calculate and output maneuver risk data 173 for the different cells 152 and assign the cells 152 corresponding maneuver risk relevance factors. The maneuver risk module 142 may output the maneuver risk data 173 to the perception module 138 for performing a Bayesian update on the different cells 152 (e.g., using equation (3), above). Thus, the perception module 138 may update the grid 150, and in some situations, the highly relevant cells 152 identified by the maneuver risk module 142 may be subsequently updated with additional sensor input 144 as will be discussed.

It will be appreciated that the maneuver risk module 142 may have different configurations, depending on whether the vehicle 100 is driven autonomously or not. For example, an autonomously driven vehicle may include a separate autonomous driving module that determines the driving maneuvers that will be performed (i.e., controls the actuator devices 128a-128n for application of brakes, turning steering wheel, etc.). In these embodiments, the maneuver risk module 142 may receive notification of the upcoming driving maneuver from the autonomous driving module, evaluate which cells 152 had more influence on the determination, and assign the cells 152 corresponding maneuver risk relevance factors. For other vehicles, the maneuver risk module 142 may operate more independently to monitor the environment, predict the risk of executing vehicle maneuvers, and identify the cells 152 that have higher influence on the prediction as being of higher relevance. In either case, the maneuver risk module 142 may output the maneuver risk data 173 to the perception module 138 for performing a Bayesian update on the different cells 152. Thus, the perception module 138 may update the grid 150, and in some situations, the highly relevant cells 152 identified by the maneuver risk module 142 may be updated with additional sensor input 144 as will be discussed.

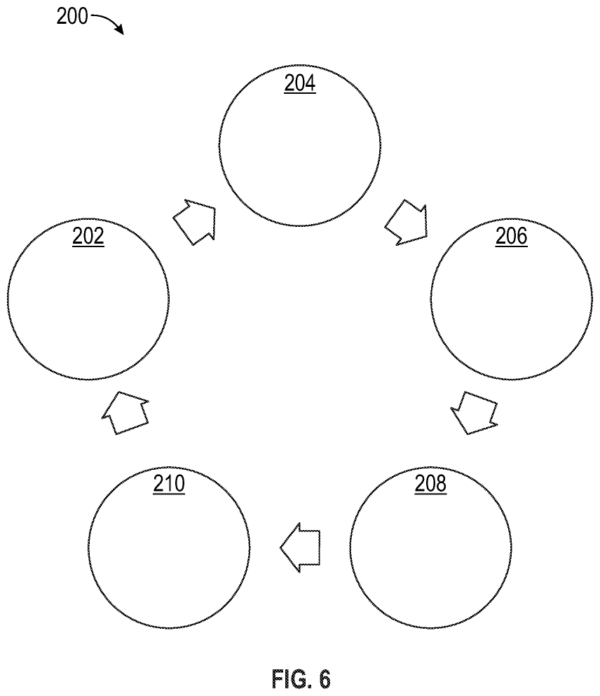

Referring now to FIG. 6, a method 200 of operating the vehicle 100 will be discussed according to example embodiments. The method 200 may begin at 202, at which the sensing devices 126a-126n provide the sensor input 144 to the controller 122. Then, at 204, the perception module 138 may generate the grid 150, including calculating individual perception data and an associated uncertainty factor for the cells 152 therein, using Bayesian algorithms (e.g., equations (1) and (2), above).

Using the grid 150 of FIG. 3 as an example, the perception module 138 may perceive characteristics of a first vehicle 301 (located at the F3 cell) and calculate a lower uncertainty factor for that cell 152. In contrast, the perception module 138 may perceive of a second vehicle 302 (located at the G3 and G4 cells) and calculate a higher uncertainty factor for those cells 152. The difference in uncertainty factor may be due to different sensing devices 126a-126n providing consistent data about the first vehicle 301 and providing inconsistent data about the second vehicle 302. The difference in uncertainty factor may also be due to the second vehicle 302 being partially hidden from view of the sensing devices 126a-126n. Additionally, the perception module 138 may detect the clouds (located in cells B1-G1) and assign high uncertainty to these cells 152 due to the ambiguous and changing shape of those clouds.

The method 200 may continue at 206. At 206, the perception module 138 may receive relevance prior data from the salience module 140 and/or from the maneuver risk module 142.

Specifically, the salience module 140 (FIG. 4) may recognize the vehicle's environment from the sensor input 144 received at 202. The salience module 140 may access the human gaze model 162 to determine where a human driver would visually attend. In the example of FIG. 3, the salience model 140 can recognize the scene and predict that a human is more likely to look at the first vehicle 301 than the clouds. Therefore, the perception module 138 may determine that the F3 cell is more relevant than the B1-G1 cells, and the perception module 138 may assign the F3 cell a higher relevance factor than the B1-G1 cells. Likewise, the perception module 138 may predict that the human driver is more likely to look at the second vehicle 302 than the first vehicle 301 (e.g., since the second vehicle 302 is closer in proximity). Therefore, the perception module 138 may provide the salience data 160, identifying the G4 cell as being more relevant than the F3 cell. Thus, the perception module 138 may assign the G4 cell a higher relevance factor than the F3 cell.

Furthermore, at 206 of the method 200, the maneuver risk module 142 (FIG. 5) may process the sensor input 144 received at 202. The maneuver risk module 142 may predict the risk associated with executing particular vehicle maneuvers. In the example of FIG. 3, the maneuver risk module 142 may determine there is relatively high risk with turning to the right since there is an object (the second vehicle 302) that would obstruct such a maneuver. The maneuver risk module 142 may determine that the sensing device(s) 126a-126n associated with the G4 cell more heavily influence that maneuver risk prediction as compared with the sensing device(s) 126a-126n of other cells 152. Therefore, the maneuver risk module 142 provide the maneuver risk data 173, assigning the G4 cell a higher relevance factor than, for example, the F3 cell.

Next, at 208 of the method 200, the adaptive sensor control system 136 may perform additional Bayesian calculations (e.g., a Bayesian update according to equation (3), above) for the cells 152 in consideration of the uncertainty factors (calculated at 204) and the relevance factors (calculated at 206). The processor 130 may assign a weight to the salience data 160 over the maneuver risk data 173 or vice versa in these calculations. The adaptive sensor control system 136 may generate control commands for one or more sensing devices 126a-126n.

Specifically, the adaptive control system 136 may generate the control commands such that one or more sensing devices 126a-126n are steered toward the physical space corresponding to the G4 cell of FIG. 3. This is because, as discussed above, the G4 call has higher uncertainty than other cells and because the G4 cell has higher relevance than other cells.

Subsequently, at 210 of the method 200, the control commands generated at 208 may be supplied from the controller 122 to the sensor system 116. For example, one or more lidar beams may be directed toward the physical space corresponding to the G4 cell. The other sensing devices 126a-126n may be tasked as well. In some embodiments, one or more sensing devices 126a-126n may be steered away from other spaces (e.g., the sky) such that limited or no sensor input is gathered therefrom. Again, the term “steered” in this context is to be interpreted broadly to mean adjusted, directed, focused, etc. to change how the sensor system 116 collects data. For example, one or more of the sensing devices 126a-126n may be steered or directed to focus, adjust resolution, turn between ON and OFF modes, gain adjustment, actuation, etc. Accordingly, sensor resources may be spent on areas determined to have high perception uncertainty and high relevance. Information gain from these areas may be increased.

The method 200 may loop back to 202, wherein additional sensor input 144 is received by the controller 122. In the current example, additional sensor input 144 is received about the space corresponding to the G4 cell. Then, repeating 204 of the method 200, the perception module 138 may calculate the perception and uncertainty factors for the cells 152. Next, at 206, relevance priors may be determined by the salience and/or maneuver risk modules 140, 142, and the adaptive sensor control system 136 may generate additional control commands for the sensing devices 126a-126n. As before, one or more sensing devices 126a-126n may be steered toward an area corresponding to a cell 152 having high perception uncertainty and high relevance to the current situation. Then, at 210, the sensing devices 126a-126n may be tasked according to the control commands determined at 208. The method may again loop back to 202, and so on.

Advantageously, the systems and methods of the present disclosure may operate with high efficiency. In an example, the sensing devices 126a-126n includes a camera configured to operate at resolution that may be selectively adjusted for a particular physical space within the environment as well as a lidar system. Once a cell 152 is identified as having higher uncertainty and relevance than others, the camera may be commanded to increase resolution (e.g., from 1080p to 4K) for the identified cell 152 instead of gathering data at this increased resolution for the entire scene. Accordingly, the system may utilize power efficiently. Also, the amount of data received as sensor input 144 can be reduced and, thus, may be managed more efficiently. Furthermore, high fidelity information may be gathered from the relevant physical spaces in the environment to thereby increase the amount of relevant information gained in each time step.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An adaptive sensor control system for a vehicle comprising:
a controller with a processor programmed to generate a perception of an environment of the vehicle, including performing a calculation upon a sensor input to provide, as an output, at least one perception datum and an associated uncertainty factor for different areas within the perception of the environment of the vehicle;
a sensor system configured to provide the sensor input to the processor, the sensor system being selectively steerable with respect to a physical space in the environment according to a control signal;
the processor programmed to determine a relevance factor for the different areas within the perception of the environment;
the processor configured to generate the control command for steering the sensor system toward a physical space in the environment as a function of the uncertainty factor and the relevance factor determined for the different areas of the perception; and
the sensor system configured to steer toward the physical space in the environment according to the control command to obtain updated sensor input for the processor to update the at least one perception datum and the associated uncertainty factor for the physical space.

2. The system of claim 1, wherein the processor is programmed to perform a Bayesian calculation upon the sensor input to provide, as the output, the at least one perception datum and the associated uncertainty factor for the different areas within the perception.

3. The system of claim 2, wherein the processor is programmed to generate and populate a cell of an occupancy grid with the at least one perception datum and the associated uncertainty factor according to the Bayesian calculation.

4. The system of claim 1, wherein the controller includes a saliency module programmed to determine a saliency relevance factor for the different areas by accessing a preprogrammed human gaze model,
the saliency module programmed to process the sensor input to:
recognize, according to the human gaze model, conditions in areas of the perception that correspond to a driving scenario stored in the human gaze model; and
indicate, according to the human gaze model, which of the areas a human driver visually attends for the recognized conditions; and
calculate the saliency relevance factor, including calculating higher saliency relevance factors for those areas a human driver visually attends; and
wherein the processor is configured to generate the control command for steering the sensor system as a function of the uncertainty factor and the saliency relevance factor.

5. The system of claim 4, wherein the saliency module processes the sensor input through a deep convolutional neural network having a multi-branch architecture including a segmentation component and an optical flow that encodes information about relative movement within an image represented in the sensor input.

6. The system of claim 1, wherein the controller includes a maneuver risk module programmed to determine a maneuver risk relevance factor for the different areas, including processing the sensor input to:
recognize a current situation of the vehicle and accordingly predict the risk of executing a particular vehicle maneuver;
determine the degree of influence that the different areas on the prediction;
calculate the maneuver risk relevance factor for the different areas according to the determined degree of influence, including calculating higher maneuver risk relevance factors for areas having higher degrees of influence; and
wherein the processor is configured to generate the control command for steering the sensor system as a function of the uncertainty factor and the maneuver risk relevance factor.

7. The system of claim 6, wherein the maneuver risk module is programmed to generate a Markov random field (MRF) to recognize the current situation.

8. The system of claim 1, wherein the sensor system includes a first sensing device and a second sensing device, the first and second sensing devices having different modalities, the first and second sensing devices configured for providing sensor input for a common area of the perception as the sensor input.

9. The system of claim 8, wherein the first sensing device includes a camera system and the second sensing device includes a lidar system.

10. The system of claim 9, wherein the processor includes a salience module and a maneuver risk module;
the salience module configured to process the sensor input from the camera system and provide salience data corresponding to the relevance factor for the different areas within the perception;
the maneuver risk module configured to process the sensor input from the lidar system and provide maneuver risk data corresponding to the relevance factor for the different areas within the perception.

11. The system of claim 1, wherein the sensor system is configured to steer toward the selected physical space area according to the control command by at least one of:
turning ON a sensing device of the sensor system between an OFF mode and an ON mode;
directing a signal from the sensing device toward the selected physical space;
actuating the sensing device toward the selected physical space;
focusing the sensing device on the selected physical space; and
changing sensor resolution of the sensing device with respect to the selected physical space.

12. A method of operating an adaptive sensor control system of a vehicle comprising:
providing sensor input from a sensor system to an on-board controller having a processor;
generating, by the processor, a perception of an environment of the vehicle, including performing a calculation upon the sensor input to provide, as an output, at least one perception datum and an associated uncertainty factor for different areas within the perception of the environment of the vehicle;
determining, by the processor, a relevance factor for the different areas within the perception of the environment;
generating, by the processor, a control command for steering the sensor system toward a physical space in the environment as a function of the uncertainty factor and the relevance factor determined for the different areas of the perception; and
steering the sensor system toward the physical space in the environment according to the control command to obtain updated sensor input for the processor to update the at least one perception datum and the associated uncertainty factor for the physical space.

13. The method of claim 12, wherein generating the perception includes:
performing, by the processor, a Bayesian calculation upon the sensor input to provide, as the output, the at least one perception datum and the associated uncertainty factor for the different areas within the perception; and
populating a cell of an occupancy grid with the at least one perception datum and the associated uncertainty factor according to the Bayesian calculation.

14. The method of claim 12,
wherein determining the relevance factor includes:
determining a saliency relevance factor for the different areas by accessing a preprogrammed human gaze model;
recognizing, according to the human gaze model, conditions in areas of the perception that correspond to a driving scenario stored in the human gaze model;
indicating, according to the human gaze model, which of the areas a human driver visually attends for the recognized conditions; and
calculating the saliency relevance factor, including calculating higher saliency relevance factors for those areas a human driver visually attends; and
wherein generating the control command includes generating the control command for steering the sensor system as a function of the uncertainty factor and the saliency relevance factor.

15. The method of claim 12,
wherein determining the relevance factor includes determining a maneuver risk relevance factor for the different areas, including processing the sensor input to:
recognize a current situation of the vehicle and accordingly predict the risk of executing a particular vehicle maneuver;
determine the degree of influence that the different areas on the prediction; and
calculate the maneuver risk relevance factor for the different areas according to the determined degree of influence, including calculating higher maneuver risk relevance factors for areas having higher degrees of influence; and
wherein generating the control command includes generating the control command for steering the sensor system as a function of the uncertainty factor and the maneuver risk relevance factor.

16. The method of claim 15, further comprising generating a Markov random field (MRF) to recognize the current situation.

17. The method of claim 12, wherein providing the sensor input includes providing the sensor input from a first sensing device and a second sensing device of the sensor system, the first and second sensing devices having different modalities, the first and second sensing devices providing sensor input for a common area of the perception.

18. The method of claim 12, wherein steering the sensor system includes at least one of:
turning ON a sensing device of the sensor system between an OFF mode and an ON mode;
directing a signal from the sensing device toward the selected physical space;
actuating the sensing device toward the selected physical space;
focusing the sensing device on the selected physical space; and
changing sensor resolution of the sensing device with respect to the selected physical space.

19. A vehicle comprising:
a controller with a processor programmed to generate a perception of an environment of the vehicle, including performing a Bayesian calculation upon a sensor input to provide an occupancy grid representing the perception, the occupancy grid populated with at least one perception datum and an associated uncertainty factor for different cells within the occupancy grid;
a sensor system configured to provide the sensor input to the processor, being selectively steerable with respect to a physical space in the environment according to a control signal, the physical space corresponding to at least one of the cells of the occupancy grid;
the processor programmed to determine a saliency relevance factor for the different cells within the occupancy grid;
the processor programmed to determine a maneuver risk relevance factor for the different cells within the occupancy grid;
the processor configured to generate the control command for steering the sensor system toward the physical space in the environment as a function of the uncertainty factor, the saliency relevance factor, and the maneuver risk relevance factor; and
the sensor system configured to steer toward the physical space according to the control command to obtain updated sensor input for the processor to update the at least one perception datum and the associated uncertainty factor for the physical space.

20. The vehicle of claim 19, wherein the sensor system is configured to steer toward the selected physical space area according to the control command by at least one of:
turning ON a sensing device of the sensor system between an OFF mode and an ON mode;
directing a signal from the sensing device toward the selected physical space;
actuating the sensing device toward the selected physical space;
focusing the sensing device on the selected physical space; and
changing sensor resolution of the sensing device with respect to the selected physical space.
